(19) United States
(12) Patent Application Publication
(10) Pub. No.: US 2023/0272648 A1
(43) Pub. Date: Aug. 31, 2023

(54) FURNITURE FITTING HAVING AT LEAST ONE ROTARY LEVER AND AT LEAST ONE BEARING PIN

(71) Applicant: Julius Blum GmbH, Hoechst (AT)

(72) Inventors: Armin BALDREICH, Lauterach (AT); Alexander Simon FLOGAUS, Eriskirch (DE); Andreas HOLZAPFEL, Bregenz (AT); Dominik HAGSPIEL, Hoechst (AT); Peter GABEL, Meiningen (DE)

(21) Appl. No.: 18/195,120

(22) Filed: May 9, 2023

Related U.S. Application Data
(63) Continuation of application No. PCT/AT2021/060409, filed on Nov. 5, 2021.

(30) Foreign Application Priority Data
Nov. 12, 2020 (AT) A 50980/2020

(51) Int. Cl. E05D 3/06

(52) U.S. Cl. CPC E05D 3/06; E05Y 2900/20

(57) ABSTRACT

A furniture fitting for the movable mounting of a furniture part, in particular a furniture flap, on a furniture panel, includes a main body, a rotary lever, and a bearing pin. The bearing pin is connected to the main body and/or to at least one base lever, and the rotary lever has a hole and the bearing pin projects through the hole. The rotary lever has, in at least one region surrounding the hole, a widened portion which extends at least in a direction parallel to a longitudinal axis of the bearing pin.

### BACKGROUND OF THE INVENTION

The invention relates to a furniture fitting for the movable mounting of a furniture part, in particular a furniture flap, on a furniture panel. Furthermore, the invention relates to a furniture panel with at least one such furniture fitting, and a piece of furniture comprising such a furniture panel. The invention also relates to a method of producing a furniture fitting.

Furniture fittings of the above-mentioned type are already known in the state of the art. The publication WO 2017/143379 A1 discloses a furniture fitting for the movable mounting of a furniture part, in particular a furniture flap, on a furniture panel comprising a main body, at least one rotary lever and at least one bearing pin, wherein the at least one bearing pin is connected to the main body and/or to at least one base lever, wherein the at least one rotary lever has at least one hole and the at least one bearing pin passes through the at least one hole.

The inner surface of the hole is mounted here directly on the bearing pin. During a rotation of the lever this naturally leads to friction and thus to wear of the bearing pin and the inner surface of the hole during use of the furniture fitting. In order to avoid excessive wear, the bearing pin and the inner surface of the hole must therefore be manufactured from a hard or hardened material or be hardened at least in places. The bearing is usually lubricated for the same purpose.

The lever is typically relatively narrow, whereby the force transmission between the bearing pin and the inner surface of the hole takes place over a small bearing surface. Relatively high friction is therefore also to be expected. Even purely statically, a small bearing surface increases the surface pressure in the bearing, which can lead to deformation of the parts. Moreover, lubrication of such a bearing proves to be difficult because of the small bearing surface.

### SUMMARY OF THE INVENTION

Starting from this state of the art, an object of the following invention is to create a furniture fitting, a furniture panel with a furniture fitting, a piece of furniture with a furniture fitting and a method for producing at least one furniture fitting, which at least partially overcomes or reduces the previously described disadvantages.

In particular, a furniture fitting for furniture panels and pieces of furniture is to be created which has a long service life and withstands high loads.

A furniture fitting according to the invention for the movable mounting of a furniture part, in particular a furniture flap, on a furniture panel comprises a main body, at least one rotary lever and at least one bearing pin. The at least one bearing pin is connected to the main body and/or to at least one base lever, and the at least one rotary lever has at least one hole and the at least one bearing pin passes through the at least one hole.

According to the invention, in at least one region surrounding the at least one hole, the at least one rotary lever has a widened portion, which extends at least in a direction parallel to a longitudinal axis of the at least one bearing pin.

Due to the enlargement of the bearing surface achieved thereby, the surface pressure is reduced and the friction is decreased. Furthermore, the bearing can be lubricated more easily.

The thus created bearing accordingly has a long service life and withstands large loads.

The widened portion on the at least one region of the at least one rotary lever surrounding the at least one hole is formed as at least one bearing bushing, wherein the at least one bearing bushing is arranged in the at least one hole. The widened portion can thus be realized simply and cost-effectively by an additional component.

In such an embodiment, the at least one bearing bushing can be connected to the at least one rotary lever and/or be passed through by the at least one bearing pin and/or be mounted rotatably with respect to the at least one bearing pin. A bearing with an enlarged bearing surface is thus formed by bearing bushing and bearing pin.

The at least one bearing bushing can be connected to the at least one rotary lever by pressing into the at least one hole of the at least one rotary lever. A simple type of connection is thus realized without additional connection means.

In an embodiment, the at least one bearing bushing is manufactured from steel. Due to the embodiment with a hard material, the wear of the bearing is kept low.

Preferably, the extent of the at least one bearing bushing in the axial direction is greater than the width of the at least one rotary lever, in particular at least five times greater. A widened portion of the inner surface of the hole is thus created, whereby the surface pressure and the wear of the bearing are reduced.

In an embodiment, the at least one bearing pin is formed as a rivet or as part of a rivet, preferably wherein the at least one bearing pin can be fastened to the main body or to the at least one base lever by orbital riveting. This represents a simple and cost-effective connection method.

At least one external spacer can be arranged between the at least one rotary lever and the main body and/or the at least one base lever, and preferably the at least one external spacer is formed as a ring and preferably wherein the bearing pin passes through the ring. The distance between the at least one rotary lever and the main body and/or the at least one base lever is thus kept constant, in particular the parts movable relative to one another thereby cannot rub against one another.

The external spacer formed as a ring can have an L-profile. Direct contact of the external spacer with the bearing bushing can thus be avoided.

In an embodiment, the furniture fitting comprises at least two rotary levers.

An internal spacer is preferably arranged between the at least two rotary levers. The internal spacer can be formed as a bushing, wherein the bushing is passed through by the bearing pin and the bearing bushing. The spacing of the at least two rotary levers is thus fixed.

Typically, the width of the at least one internal spacer substantially corresponds to the distance between the at least two rotary levers.

The internal diameter of a bushing used as an internal spacer can substantially correspond to the outer radius of the bearing bushing.

The at least two rotary levers can be connected via the widened portion in at least one region surrounding the at least one hole. A common widened portion of the at least two rotary levers is thus created, whereby the bearing surface can be enlarged more easily than in the case of a single lever.

The at least two rotary levers can be connected to one another away from the hole, preferably wherein the at least two rotary levers can be molded from one part, welded, screwed and/or riveted. A more stable multiple lever unit is thus created.

At least two rotary levers can be arranged parallel to one another. Multiple levers can thus be realized compactly.

At least two rotary levers can also be formed substantially identical, which reduces the production costs.

In an embodiment, a bearing bushing is arranged in the holes of the at least two rotary levers, with the result that the bearing bushing passes through the at least two rotary levers. A widened bearing and thus a larger bearing surface are thus created by means of a bearing bushing.

In an embodiment, the furniture fitting can comprise at least two base levers.

The at least one bearing pin passes through the at least two base levers. The bearing pin is thus held by both base levers.

The at least two base levers are connected to one another, preferably wherein the at least two base levers are molded from one part, welded, screwed and/or riveted.

It is envisaged that the at least two base levers are arranged parallel to one another and/or the at least two base levers are formed substantially identical. A cost-effective production and a compact arrangement of the base levers are thus made possible.

The at least one rotary lever and the at least one base lever are arranged nested along the longitudinal axis of the at least one bearing pin. A stable construction can thus be realized.

In an embodiment, the arrangement along the longitudinal axis of the at least one bearing pin has the following sequence:
at least one, preferably precisely one, base lever
at least one, preferably precisely one or precisely two, rotary levers
at least one, preferably precisely one, base lever

For example, a bearing bushing can be pressed into the holes of the inner two rotary levers, whereby a double lever is created. Two base levers can be mounted rotatably outside via the bearing pin.

In an embodiment, the furniture fitting has at least one spring element, which does not necessarily have the properties of base lever or rotary lever. The spring element can be formed as an elastic lever, which is stretched between two bearings. A force is thus exerted on both bearings. In the case of a load change transverse to the direction of force, a jumping of a bearing pin in a hole and/or a bearing bushing can be avoided in this way, as the bearing pin slides along on the inner surface of the hole and/or the bearing bushing due to the force applied by the spring element.

The at least one rotary lever, the at least one base lever and the at least one spring element can be arranged nested along the longitudinal axis of the at least one bearing pin, preferably wherein an arrangement along the longitudinal axis of the at least one bearing pin has the following sequence:
at least one, preferably precisely one, base lever
at least one, preferably precisely one, rotary lever
at least one, preferably precisely one, spring element
at least one, preferably precisely one, rotary lever
at least one, preferably precisely one, base lever

In an embodiment, the at least one spring element can be mounted rotatably on the outside of the at least one bearing bushing. The bearing bushing thus functions as a bearing pin for the bearing between rotary lever and spring element. A rotation of the spring element with respect to the rotary lever is typically not provided in operation of the furniture fitting, but only for the installation of the spring element.

In an embodiment, the main body has a housing with at least two side walls, wherein the at least one bearing pin is arranged in at least two holes in the at least two side walls. At least one rotary lever, for example, can thus be mounted rotatably with respect to the main body.

A preferred arrangement along the longitudinal axis of the at least one bearing pin has the following sequence:
side wall
at least one, preferably precisely one or precisely two, rotary levers
side wall

In an embodiment, the furniture fitting can have an actuating mechanism. A furniture part, for example, can thus be moved relative to the main body.

For the installation of the movable furniture part, the actuating mechanism has at least one installation lever, preferably wherein the installation lever functions as a rotary lever and/or base lever.

The actuating mechanism comprises a number of levers, wherein at least some of the number of levers are formed as base levers and/or rotary levers. The actuating mechanism thus has the above-mentioned advantages of the invention: it withstands higher loads, among other things, is easier to lubricate and wears more slowly.

At least one lever of the number of levers of the actuating mechanism can be formed as rotary lever and base lever. A lever can thus be connected at one end, for example, to a bearing bushing and function as a rotary lever, while the same lever can be connected at another end to a bearing pin and functions as a base lever.

In an embodiment, the main body has a, preferably mechanical, energy storage mechanism, wherein the coupling point of the energy storage mechanism on the actuating mechanism is adjustable on the front surface of the main body. In the installed position the main body thus only has to be accessible on its front surface.

In at least one position, preferably a closing position, the actuating mechanism can be arranged completely in the main body. The main body can thus be built in, for example into a furniture panel. Only one side, preferably the front face, must remain free.

According to an embodiment, the main body has a fastening device, wherein the fastening device is accessible from the front surface of the main body. Access to the fastening device is necessary for installation and disassembly. The main body can thus be built in, for example into a furniture panel, wherein only the front face of the main body remains free.

At least one nub can be provided on the side surfaces of the main body, whereby the main body can be supported on a furniture panel. The main body is thus safeguarded against tilting sideways.

The main body can have a housing, wherein the housing is open on the front face. In one position, preferably an open position, the actuating mechanism can thus protrude from the main body on the front face.

A furniture panel with at least one above-described furniture fitting is provided. A furniture part can thus be moved relative to the furniture panel.

In an embodiment of the furniture panel, the at least one furniture fitting is arranged at least partially in a recess in the furniture panel. The furniture fitting is thus at least partially integrated in the furniture panel. The furniture fitting can thus be arranged in a space-saving manner and so as not to be very visible.

The recess can be open towards at least a front face of the furniture panel and/or be open towards at least a side surface of the furniture panel. The furniture fitting is thus accessible from the front face and/or the side surface. Furthermore, the actuating mechanism can pivot out in the direction of the front face in order to move a movable furniture part.

A piece of furniture comprising at least one above-described furniture panel is provided. The thus created device has the advantages of the furniture fitting and the furniture panel.

The piece of furniture can comprise at least one movable furniture part, wherein the at least one movable furniture part is fastened to the piece of furniture by means of the at least one furniture fitting.

Here the at least one movable furniture part can be formed as a furniture flap. The furniture fitting can thus be used to bring about the opening and closing of a furniture flap.

The at least one furniture fitting can make a vertical opening of the at least one movable furniture part possible. A furniture flap can thus be opened vertically upwards (or downwards).

### BRIEF DESCRIPTION OF THE DRAWINGS

Further details and advantages of the invention are explained in more detail below by means of the description of the figures with reference to the drawings, in which:

FIGS. 1a,b show piece of furniture with a furniture fitting integrated in a side wall and furniture flap, 1a perspective representation, 1b exploded representation,

FIG. 2 shows furniture fitting in an exploded representation,

FIGS. 3a-c show a furniture fitting with a bearing consisting of bearing bushing and bearing pin, 3a exploded representation, 3b sectional representation, 3c detailed view of sectional representation,

FIGS. 4a,b show an actuating mechanism of the furniture fitting, 4a perspective representation, 4b exploded representation,

FIG. 5 is an alternative exploded representation of the actuating mechanism,

FIGS. 6a-k show various bearings of the actuating mechanism, 6a side view of the actuating mechanism, 6b-f sections through the bearings, 6g-k detailed views of the sections through the bearings

FIGS. 7a-f are a sectional representation of a bearing, 7a complete bearing, 7b-e production steps in a detailed view,

FIGS. 8a-f are a sectional representation as a detail and overview of the production steps of a further bearing

### DETAILED DESCRIPTION OF THE INVENTION

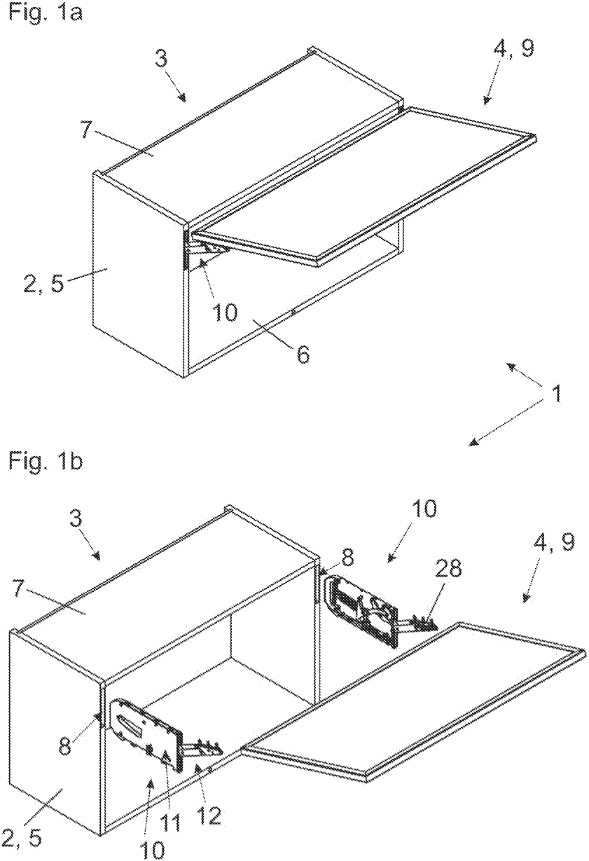

FIGS. 1a,b show a piece of furniture 1 comprising a furniture carcass 3. The furniture carcass 3 for its part comprises a furniture top panel 7 and a furniture base panel 6. Furthermore, the piece of furniture 1 comprises two furniture panels 2, which form the side walls 5 of the furniture carcass 3.

On their front faces the side walls 5 have a recess 8, in which a furniture fitting 10 is countersunk. In FIG. 1a, the furniture fittings 10 are shown in the countersunk state, while in the exploded representation in FIG. 1b the furniture fittings are represented not installed. Due to the integration of the furniture fitting 10 into the side walls 5, no space is taken away inside the furniture carcass 3. An inconspicuous installation of the furniture fittings 10 is also made possible.

The furniture fitting 10 comprises a main body 11 and an actuating mechanism 12. In FIGS. 1a,b the furniture fitting 10 is shown in an open position, in which the actuating mechanism 12 protrudes from the main body 11 on the front face.

The actuating mechanism 12 has an installation lever 28, on which a movable furniture part 9 can be installed. In the present embodiment, the movable furniture part 9 is formed as a furniture flap 4.

FIG. 1a shows a furniture flap 4 installed on the actuating mechanism 12, while the exploded representation in FIG. 1b shows a furniture flap 4 that has not been installed.

The furniture flap 4 can be opened vertically by the actuating mechanism 12 of the two furniture fittings 10. However, the furniture fitting 10 can also be used for a furniture door, wherein the furniture door is opened horizontally.

The recess 8 in the furniture panel 2, in which the furniture fitting 10 can be received, can be open, as in FIGS. 1a,b, to at least a front face of the furniture panel 2 and/or to at least a side surface of the furniture panel 2. In particular in the case of the former embodiment, accessibility for adjustment possibilities on the furniture fitting 10 from its front face is to be guaranteed.

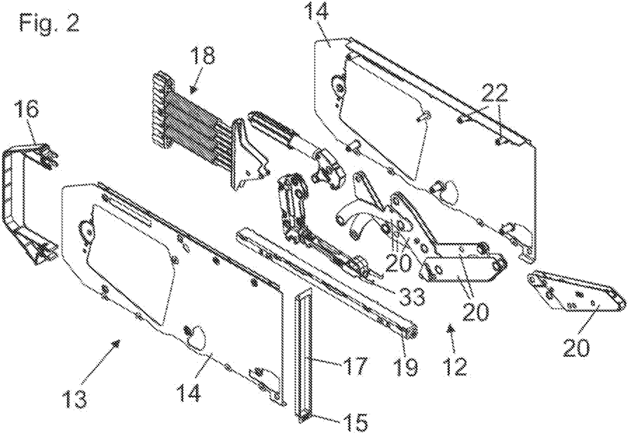

FIG. 2 shows a furniture fitting 10 in an exploded representation. The housing 13 of the main body 11 of the furniture fitting 10 has two side walls 14, a front face 15 and a rear face 16.

An opening 17, through which the actuating mechanism 12 can protrude outwards in an open position, is provided on the front face 15.

In at least one position, preferably a closing position, the actuating mechanism 12 can be arranged substantially completely in the main body 11. If the furniture fitting 10 is integrated in a furniture panel 2, this construction is necessary.

The main body 11 has an energy storage mechanism 18, wherein the coupling point of the energy storage mechanism 18 on the actuating mechanism 12 is adjustable on the front face 15 of the main body 11. The adjustment can be effected via an adjustment part 33.

The main body 11 has a fastening device 19, wherein the fastening device 19 is accessible from the front face 15 of the main body 11. The main body can be fastened in the recess 8 of the furniture panel 2 with the fastening device 19.

The nubs on the side walls 14 of the main body 11 are not visible in FIG. 2. The main body 11 can be supported in the recess 8 of the furniture panel 2 with the nubs. The furniture fitting 10 is thus protected against tilting.

The actuating mechanism 12 comprises a number of levers 20, wherein at least some of the number of levers 20 are formed as base levers 22 and/or as rotary levers 21, wherein at least one lever 20 of the number of levers 20 is formed as a rotary lever 21 and base lever 22.

The levers 20 are connected to one another and/or to the side walls 14 of the main body 11 via bearings 30. For this purpose the levers 20 have at least one hole 23, which is passed through by a bearing pin 24.

The base levers 22 are connected fixedly to a bearing pin 24, while the rotary levers 21 are mounted rotatably on a bearing pin 24. One lever 20 of the number of levers 20 can have more than one, in particular two, bearings 30 and accordingly act as rotary lever 21 and base lever 22 at the same time.

Since the levers 20 are typically narrow, the bearing surface of bearings which are formed substantially by means of a bearing pin 24 is relatively small. The surface pressure and the friction on the bearing surfaces are thus great. In order to avoid excessive wear, a widened portion of the bearing surface is provided according to the invention.

In the embodiments of the following figures, the widened portion is realized by means of a bearing bushing 25, which is pressed into a hole 23 in a rotary lever 21.

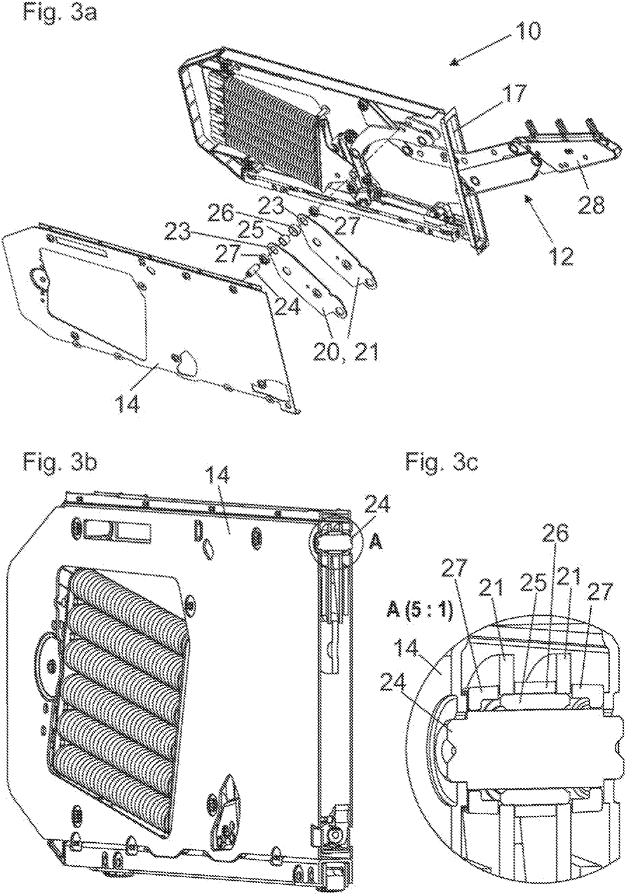

A bearing 30 of the actuating mechanism 12 is shown in an exploded representation in FIG. 3a and in a sectional representation in FIGS. 3b, c.

Here a bearing pin 24 is fixedly connected to the side walls 14 of the main body 11. Moreover, two rotary levers 21 are shown with in each case at least one hole 23. The bearing pin 24 passes in each case through a hole 23 of both rotary levers 21. In at least one region surrounding the at least one hole 23, the two rotary levers 21 have a widened portion 31, which extends at least in a direction parallel to a longitudinal axis of the at least one bearing pin 24.

In the embodiment in FIGS. 3a-c, this widened portion 31 is formed by a bearing bushing 25, wherein the bearing bushing 25 is arranged in each case in a hole 23 of the rotary levers 21. The bearing bushing 25 is thus connected to both rotary levers 21 and represents a widened portion 31 of both rotary levers.

In order to create a bearing 30 with an enlarged bearing surface, the bearing bushing 25 is passed through by the bearing pin 24 and is mounted rotatably on the bearing pin 24.

The connection between the rotary levers 21 and the bearing bushing 25 is achieved by pressing into the holes 23 of the rotary levers 21. The two rotary levers 21 thus form a double lever.

The two rotary levers 21 are arranged parallel to one another, and/or the at least two rotary levers 21 are formed substantially identical. The two rotary levers 21 can thus be manufactured cost-effectively and can be punched together, for example.

In order to realize a low-wear bearing 30, it is furthermore provided that the bearing bushing 25 is manufactured from steel.

In order to be able to connect both rotary levers 21 and to create a large bearing surface, the extent of the at least one bearing bushing 25 in an axial direction is greater than the width of the at least one rotary lever 21, in particular at least five times greater.

The bearing pin 24 is formed as a rivet 32 or as a part of a rivet 32 here. The fixing on the main body 11 is effected here by orbital riveting of the rivet on both sides. However, it can also be effected by orbital riveting on one side.

An external spacer 27 between the at least one rotary lever 21 and the main body 11 can also be seen from FIGS. 3a-c, wherein the at least one external spacer 27 is designed as a ring. It can be seen from FIG. 3c that the ring has an L-profile. A contact with the bearing bushing 25 is thus avoided. The bearing pin 24 passes through the ring here.

It can also be seen in FIGS. 3a-c that an internal spacer 26 is arranged between the at least two rotary levers 21. In this embodiment the internal spacer 26 is formed as a bushing.

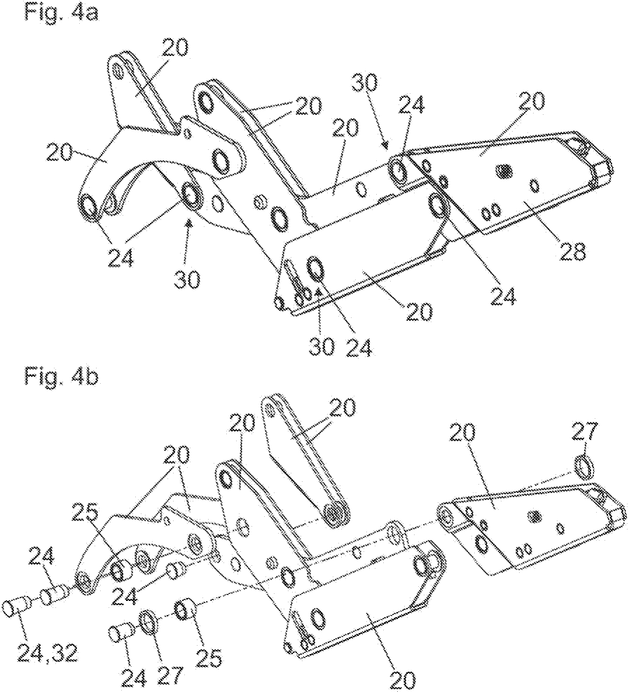

FIGS. 4a,b show an actuating mechanism 12 with several levers 20, which are connected to one another via bearings 30. Bearings 30 which have a bearing pin 24 and a bearing bushing 25 are included. The bearing pins 24 are connected fixedly to the respective base levers 22, wherein the bearing bushings 25 are connected to the rotary levers 21 and are mounted rotatably with respect to the bearing pin 24. As mentioned above, a lever 20 can function as a rotary lever 21 and base lever 22, as it can have more than one bearing 30.

The levers 20, both base levers 22 and rotary levers 21, can be formed differently.

As mentioned with regard to FIGS. 3a-c, a rotary lever 21 can be formed as a double lever. Two rotary levers 21 can be connected to one another via the bearing bushing 25. Likewise, two base levers 22 can be connected to one another via a bearing bushing 25.

At least two levers 20, base levers 22 or rotary levers 21, can be connected to one another away from a bearing 30, for example the at least two rotary levers 21 can be molded from one part, welded, screwed and/or riveted.

The levers 20 are arranged nested along the longitudinal axis of the at least one bearing pin 24.

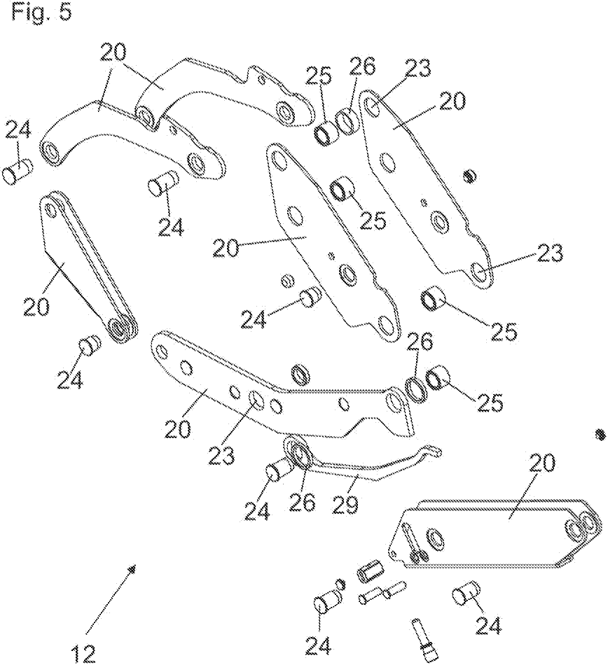

FIG. 5 shows a further exploded representation of the actuating mechanism 12. In addition to the explanations with regard to FIGS. 4a,b, a spring element 29 is shown here.

A bearing 30 which connects a rotary lever 21 and a base lever 22 to one another rotatably relative to one another can also represent the fulcrum of a spring element 29. Here the spring element 29 is mounted rotatably on a widened portion 31, for example a bearing bushing 25, of the rotary lever 21.

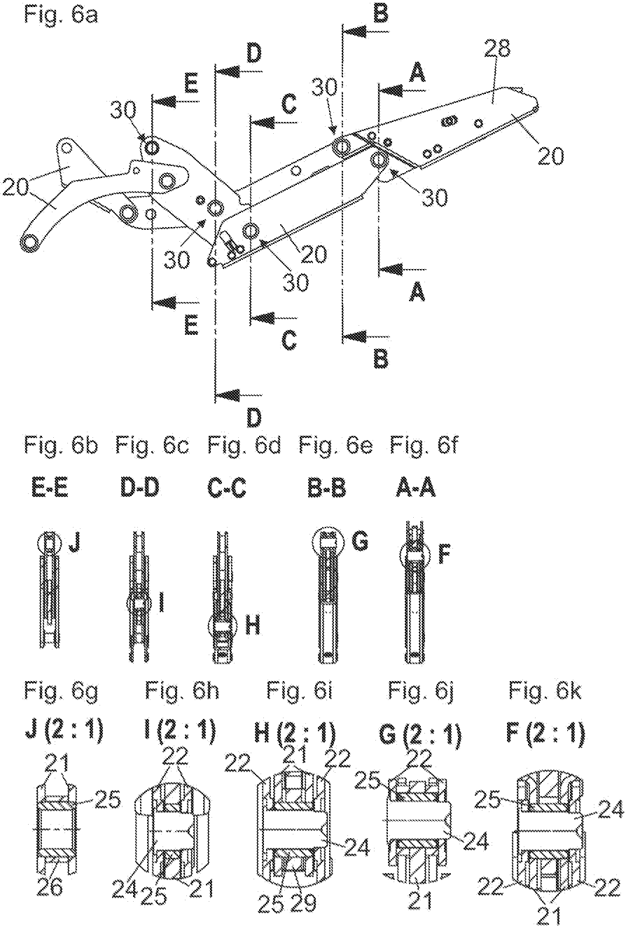

FIG. 6a shows an actuating mechanism 12 in a side view. The section planes A-E marked in FIG. 6a through the bearings 30 are represented in FIGS. 6b-f. A detailed view of the regions F-J of the bearings 30 is represented in FIGS. 6g-k.

The nested arrangement of the levers 20 can easily be seen from FIGS. 6b-k.

FIGS. 6b and 6g (section plane E) show a bearing 30 of the type of bearing discussed in FIGS. 3a-c. This bearing 30 connects the actuating mechanism 12 to the side walls 14 of the main body 11, wherein the side walls 14 are not represented here. The bearing pin 24 and the external spacers 27 are also missing in the representation.

Two rotary levers 21 arranged in parallel are shown, which are connected via a bearing bushing 25. Furthermore, the internal spacer 26, which is formed as a bushing, can be seen. The internal spacer 26 fixes the distance between the two rotary levers 21. The internal diameter of the internal spacer 26 substantially corresponds to the outer diameter of the bearing bushing 25.

The arrangement along the axis of symmetry, marked as a dotted line and corresponding to the longitudinal axis of the bearing pin 24 (not represented), has the following sequence:
side wall 14
two rotary levers 21
side wall 14

FIGS. 6c and 6h (section plane D) show a bearing 30 which connects two base levers 22 to a rotary lever 21, wherein the rotary lever 21 is arranged between the two base levers 22. The two base levers 22 are formed substantially identical here.

The bearing bushing 25 is connected to the rotary lever 21 and mounted on the bearing pin 24. The bearing pin 24 is formed as a one-sided rivet. During an installation the rivet only has to be fastened on one side, for example by orbital riveting.

The arrangement along the longitudinal axis of the at least one bearing pin 24 (dashed line) has the following sequence:
a base lever 22
a rotary lever 21
a base lever 22

FIGS. 6d and 6i (section plane C) show a bearing 30 which connects two base levers 22 to two rotary levers 21. Furthermore, a spring element 29 is shown here.

The bearing bushing 25 is pressed, as in the case of the bearing 30 from section plane E, into the holes 23 of both rotary levers 21 and connects these. A bearing pin 24 formed as a one-sided rivet is visible in the bearing bushing.

On the outside of the bearing bushing 25, a spring element 29 is attached and mounted rotatably relative to the two rotary levers 21 and the two base levers 22.

The spring element 29 is formed as an elastic lever, which is stretched between two bearings 30. A force is thus exerted on both bearings 30. In the case of a load change, a jumping of the bearing pin 24 in a hole 34 and/or a bearing bushing 25 can be avoided in this way. In the present embodiment, the spring element is stretched between the two bearings 30 of the section planes A and C.

The position of the spring element 29 with respect to the bearing bushing 24 on which the spring element 29 is mounted rotatably is fixed by clamping. The rotatable mounting is thus used only during the installation of the actuating mechanism 12, but not in operation of the furniture fitting 10.

The arrangement along the longitudinal axis of the at least one bearing pin 24 has the following sequence:
a base lever 22
a rotary lever 21
a spring element 29
a rotary lever 21
a base lever 22

FIGS. 6e and 6j (section plane B) show a bearing 30 which connects two base levers 22 to one rotary lever 21. The rotary lever 21 is arranged between the two base levers 22. Here the two base levers 22 are part of an installation lever 28 of the actuating mechanism 12. In this sense, the two base levers 22 are connected to one another away from the bearing 30. The bearing pin 24 is formed as a one-sided rivet.

FIGS. 6f and 6k (section plane A) show a bearing 30 which has two base levers 22 and two rotary levers 21. The rotary levers 21 are arranged between the two base levers 22 and connected via a bearing bushing 25. Here the rotary levers 21 are part of the installation lever 28 of the actuating mechanism 12. The bearing pin 24 is formed as a one-sided rivet.

The end of the spring element 29 which, with a hole arranged at the opposite end, is attached to the bearing bushing 25 of the bearing 30 of the section plane C is also visible.

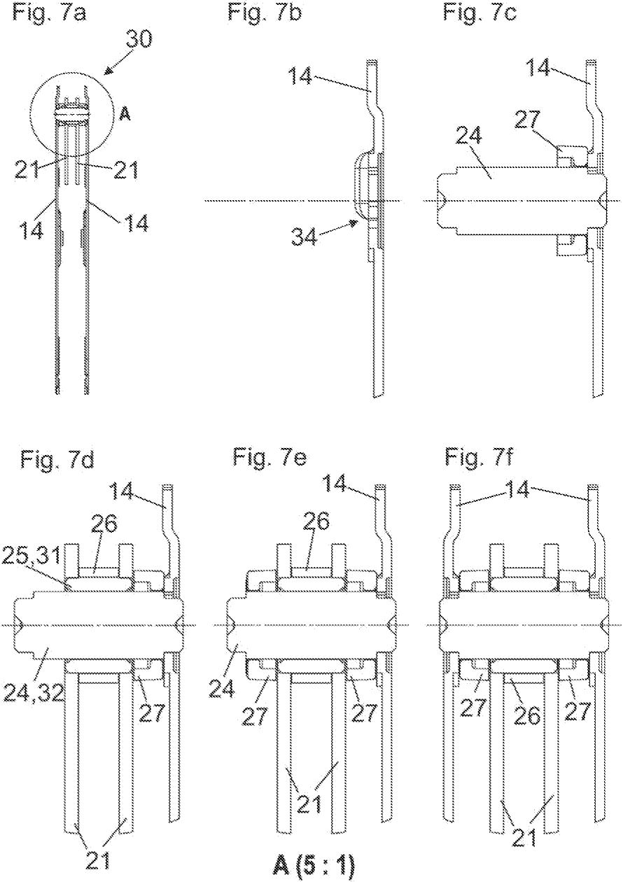

FIGS. 7a-f show a bearing 30 which is of the type of bearing 30 shown in FIGS. 6b and 6g (section plane E). Here two rotary levers 21 are connected rotatably to the side walls 14 of the main body 11.

FIG. 7a shows a section through the bearing 30. FIGS. 7b-f show the production steps of the bearing in an enlarged region A of FIG. 7a.

A method for producing a furniture fitting 10 has the following method steps:

A first side wall 14 of the main body 11 is provided (see FIG. 7b). The first side wall 14 has at least one hole 34. FIG. 7b also shows the axis of symmetry defined by the hole as a dashed line. In an alternative embodiment, a base lever 22 with hole 34 is provided (not shown here).

In a further method step (see FIG. 7c) a bearing pin 24 is introduced into the hole 34 of the first side wall 14 of the main body. Furthermore, an internal spacer 27 can already encircle the bearing pin 24 here. The internal spacer 27 is formed here as a ring with an L-shaped profile. The internal spacer 27 can also be attached in an additional method step.

In a further method step (see FIG. 7d) two rotary levers 21, which are connected to one another via a bearing bushing 25, are pushed over the bearing pin 24, with the result that the bearing pin passes through the hole 23 in the rotary lever 21. The bearing bushing 25 is connected firmly to the two rotary levers 21 and thus represents a widened portion 31 of the two rotary levers 21. In order to maintain the distance of the two rotary levers 21, an internal spacer 26 formed as a bushing is attached encircling the bearing bushing 25.

In a further method step (see FIG. 7e) a second external spacer 27 is attached encircling the bearing pin 24.

In a last step, the second side wall 14 of the main body 11 is attached to the bearing pin 24. The bearing pin 24 is thus arranged between the two side walls 14 of the main body.

In FIGS. 7a-f the bearing pin 24 is formed as a rivet. A fastening can be brought about by means of orbital riveting.

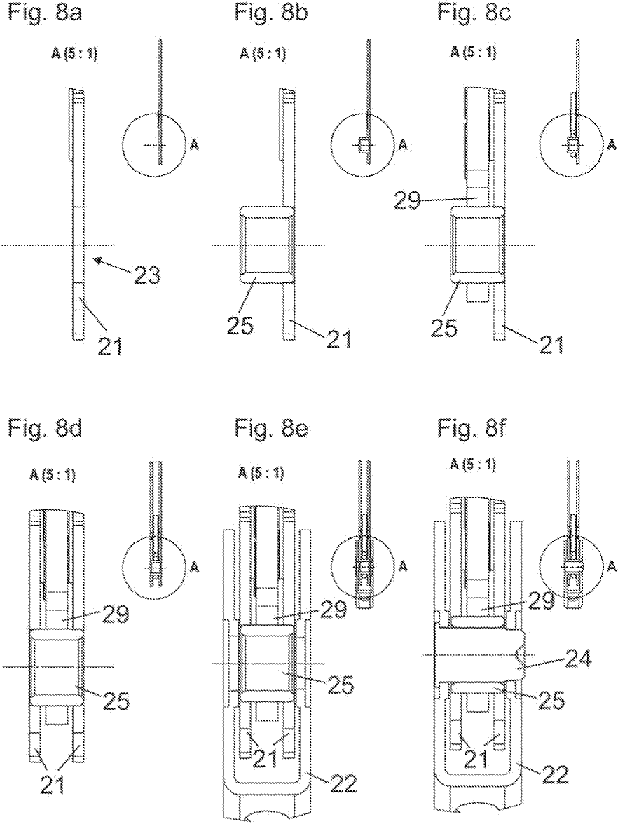

FIGS. 8a-f show alternative method steps for the production of a bearing 30 with spring element 29, as in FIGS. 6d and 6i. The method has the following method steps. A detailed view of the bearing 30 in the region A is shown in each figure, wherein the region A is likewise marked.

A rotary lever 21 with a hole 23 is provided (see FIG. 8a).

A bearing bushing 25 is introduced into the hole 23 (see FIG. 8b). A firm connection can be produced by pressing in.

A spring element 29 is attached around the bearing bushing 25 (see FIG. 8c). For this purpose the spring element 29 likewise has a hole, which is passed through by the bearing bushing 25 in the installed state. The bearing bushing 25 thus functions as a bearing pin of the spring element 29.

A second rotary lever 21 is arranged with a hole 23 such that the bearing bushing 25 is arranged in the hole 23 (see FIG. 8d). The connection between rotary lever 21 and bearing bushing 25 can be brought about by pressing in.

In a further method step, the two base levers 22, which are connected to one another in this embodiment, are arranged around the bearing bushing 25 (see FIG. 8e).

The bearing pin 24 is inserted through the bearing bushing 25 and the holes 34 of the base levers 22.

Here the bearing pin 24 is formed as a one-sided rivet. The fastening of the rivet can be realized by orbital riveting.

List of reference numbers:

| | |
|---|---|
| 1 | piece of furniture |
| 2 | furniture panel |
| 3 | furniture carcass |
| 4 | furniture flap |
| 5 | side wall |
| 6 | furniture base panel |
| 7 | furniture top panel |
| 8 | recess |
| 9 | movable furniture part |
| 10 | furniture fitting |
| 11 | main body |
| 12 | actuating mechanism |
| 13 | housing |
| 14 | side wall of the main body |
| 15 | front face of the main body |
| 16 | rear face of the main body |
| 17 | opening on the front face |
| 18 | energy storage mechanism |
| 19 | fastening device |
| 20 | lever |
| 21 | rotary lever |
| 22 | base lever |
| 23 | hole |
| 24 | bearing pin |
| 25 | bearing bushing |
| 26 | internal spacer |
| 27 | external spacer |
| 28 | flap lever |
| 29 | spring element |
| 30 | bearing |
| 31 | widened portion |
| 32 | rivet |
| 33 | adjustment part |
| 34 | hole in base lever or in the side wall of the main body |

1. A furniture fitting for the movable mounting of a furniture part, in particular a furniture flap, on a furniture panel, comprising:
a main body;
at least one rotary lever; and
at least one bearing pin,
wherein the at least one bearing pin is connected to the main body and/or to at least one base lever, wherein the at least one rotary lever has at least one hole and the at least one bearing pin passes through the at least one hole, wherein in at least one region surrounding the at least one hole, the at least one rotary lever has a widened portion extending at least in a direction parallel to a longitudinal axis of the at least one bearing pin.

2. The furniture fitting according to claim 1, wherein the at least one base lever is connected fixedly to the at least one bearing pin and wherein the at least one rotary lever is mounted rotatably on the at least one bearing pin.

3. The furniture fitting according to claim 1, wherein the widened portion is formed on the at least one region of the at least one rotary lever surrounding the at least one hole as at least one bearing bushing, wherein the at least one bearing bushing is arranged in the at least one hole, preferably wherein
the at least one bearing bushing is connected to the at least one rotary lever, and/or
the at least one bearing bushing is passed through by the at least one bearing pin, and/or
the at least one bearing bushing is mounted rotatably with respect to the at least one bearing pin, and/or
the at least one bearing bushing can be connected to the at least one rotary lever by pressing into the at least one hole of the at least one rotary lever, and/or
the at least one bearing bushing is manufactured from steel, and/or
the extent of the at least one bearing bushing in the axial direction is greater than the width of the at least one rotary lever, in particular at least five times greater.

4. The furniture fitting according to claim 1, wherein the at least one bearing pin is formed as a rivet or as part of a rivet, preferably wherein the at least one bearing pin can be connected to the main body or to the at least one base lever by orbital riveting.

5. The furniture fitting according to claim 1, wherein at least one external spacer is arranged between the at least one rotary lever and the main body and/or the at least one base lever, preferably wherein the at least one external spacer is formed as a ring, preferably wherein the bearing pin passes through the ring, and/or preferably wherein the ring has an L-profile.

6. The furniture fitting according to claim 1, wherein the furniture fitting comprises at least two rotary levers, preferably wherein:
an internal spacer is arranged between the at least two rotary levers, preferably wherein the internal spacer is formed as a bushing, and/or
the at least two rotary levers are connected via the widened portion in at least one region surrounding the at least one hole, and/or
the at least two rotary levers are connected to one another away from the hole, preferably wherein the at least two rotary levers are molded from one part, welded, screwed and/or riveted, and/or
the at least two rotary levers are arranged parallel to one another, and/or
the at least two rotary levers are formed substantially identical.

7. The furniture fitting according to claim 3, wherein a bearing bushing is arranged in the at least two holes of the at least two rotary levers, with the result that the bearing bushing passes through the at least two rotary levers.

8. The furniture fitting according to claim 1, wherein the furniture fitting comprises at least two base levers, preferably wherein:
the at least one bearing pin passes through the at least two base levers, and/or
the at least two base levers are connected to one another, preferably wherein the at least two base levers are molded from one part, welded, screwed and/or riveted, and/or
the at least two base levers are arranged parallel to one another, and/or
the at least two base levers are formed substantially identical.

9. The furniture fitting according to claim 1, wherein the at least one rotary lever and the at least one base lever are arranged nested along the longitudinal axis of the at least one bearing pin, preferably wherein the arrangement along the longitudinal axis of the at least one bearing pin has the following sequence:
at least one, preferably precisely one, base lever,
at least one, preferably precisely one or precisely two, rotary levers,
at least one, preferably precisely one, base lever.

10. The furniture fitting according to claim 1, wherein the furniture fitting has at least one spring element, preferably wherein the at least one rotary lever, the at least one base lever and the at least one spring element are arranged nested along the longitudinal axis of the at least one bearing pin, preferably wherein an arrangement along the longitudinal axis of the at least one bearing pin has the following sequence:
at least one, preferably precisely one, base lever,
at least one, preferably precisely one, rotary lever,
at least one, preferably precisely one, spring element,
at least one, preferably precisely one, rotary lever,
at least one, preferably precisely one, base lever.

11. The furniture fitting according to claim 3, wherein the at least one spring element is mounted rotatably on the outside of the at least one bearing bushing.

12. The furniture fitting according to claim 1, wherein the main body has a housing with at least two side walls, wherein the at least one bearing pin is arranged in at least two holes in the at least two side walls, preferably wherein an arrangement along the longitudinal axis of the at least one bearing pin has the following sequence:
side wall,
at least one, preferably precisely one or precisely two, rotary levers,
side wall.

13. The furniture fitting according to claim 1, wherein the furniture fitting has an actuating mechanism, wherein:
the actuating mechanism comprises a number of levers, wherein at least some of the number of levers are formed as base levers and/or as rotary levers, preferably wherein at least one lever of the number of levers is formed as a rotary lever and base lever, and/or
the main body has a, preferably mechanical, energy storage mechanism, wherein the coupling point of the energy storage mechanism on the actuating mechanism is adjustable on the front face of the main body, and/or
in at least one position, preferably a closing position, the actuating mechanism can be arranged completely in the main body, and/or
the actuating mechanism has at least one installation lever, wherein a movable furniture part can be fastened to the installation lever, preferably wherein the installation lever functions as a rotary lever and/or base lever.

14. The furniture fitting according to claim 1, wherein:
the main body has a fastening device, wherein the fastening device is accessible from the front face of the main body, and/or
at least one nub is provided on the side walls of the main body, whereby the main body can be supported on a furniture panel, and/or
the main body has a housing, wherein the housing is open on the front face.

15. The furniture panel with at least one furniture fitting according to claim 1.

16. The furniture panel according to claim 15, wherein the at least one furniture fitting is arranged at least partially in a recess in the furniture panel, preferably wherein the recess:
is open towards at least a front face of the furniture panel, and/or
is open towards at least a side surface of the furniture panel.

17. A piece of furniture comprising the furniture panel according to claim 15.

18. The piece of furniture according to claim 17, wherein the piece of furniture comprises at least one movable furniture part, wherein the at least one movable furniture part is fastened to the piece of furniture by means of the at least one furniture fitting, preferably wherein:
the at least one movable furniture part is formed as a furniture flap, and/or
the at least one furniture fitting makes a vertical opening of the at least one movable furniture part possible.

19. A method for producing at least one furniture fitting according to claim 1, comprising the following method steps:
at least one base lever and/or a first side wall of the main body is provided,
the at least one bearing pin is introduced into at least one hole of the at least one base lever and/or the first side wall of the main body,
at least one rotary lever is arranged such that the at least one bearing pin passes through the at least one hole of the at least one rotary lever, wherein the at least one widened portion rests flat against the at least one bearing pin,
at least one further base lever and/or a second side wall of the main body is arranged such that the at least one bearing pin passes through the at least one hole of the at least one base lever and/or the second side wall of the main body.

20. The method according to claim 19, wherein at least one of the following method steps is provided:
at least one internal spacer is attached such that the at least one internal spacer encircles the widened portion,
at least one spring element is attached such that at least one hole in the at least one spring element encircles the widened portion,
at least one external spacer is attached such that the at least one external spacer encircles the at least one bearing pin.

21. The method according to claim 19, wherein the widened portion of the furniture fitting is formed as a bearing bushing and at least one of the following method steps is provided:
at least one rotary lever with at least one hole is provided,
the bearing bushing is arranged in the at least one hole of the at least one rotary lever,
the bearing bushing is fastened by pressing into the at least one hole of the at least one rotary lever.

22. The method according to claim 19, wherein the at least one bearing pin, which is formed as a rivet or as part of a rivet, is fastened by orbital riveting.
